(19) United States
(12) Patent Application Publication
(10) Pub. No.: US 2004/0191477 A1
(43) Pub. Date: Sep. 30, 2004

(54) Method of making an interior trim part and article made by the process

(75) Inventors: Joseph J. Davis JR., Ortonville, MI (US); Sarkis B. Mikhjian, Rochester Hills, MI (US); Timothy L. Peak, N. Liberty, IA (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/396,875

(22) Filed: Mar. 24, 2003

(51) Int. Cl. B32B 1/00; B29C 41/08; B29C 44/12; B29C 59/00; B29C 71/02

(52) U.S. Cl. 428/141; 264/46.4; 264/236; 264/250; 264/293; 264/294

(57) ABSTRACT

A method of making a skin of an interior trim part and an interior trim part made according to the process. A male mold having a convex portion is used to form a skin having a uniform thickness that is sprayed on the surface of the mold. The surface of the mold has a grain pattern that is transferred to a skin. The skin is allowed to flash off or partially cure before being removed from the male mold. The skin is then turned inside out with the exterior surface being inverted to form a convex portion of the skin. The skin is placed into a female mold having a concave portion against which the convex portion of the skin is placed. Foam is injected into the inverted skin while in a female mold and is cured to form an interior trim part.

### BACKGROUND OF THE INVENTION

1. Field of the Invention

The present invention relates to a method of making an interior trim part for a vehicle such as an instrument panel.

2. Background Art

Instrument panels are made by forming an elastomeric skin that is backed by a resilient, relatively rigid foam. When an instrument panel includes a sharply contoured portion, problems may be encountered in forming a skin having uniform thickness. Thickness irregularities may result in surface imperfections and high scrap rates.

In particular, instrument panels frequently feature a brow above the instrument cluster that is relatively sharp. When the skin portion of the instrument panel is formed in the prior art process, a concave, or female, mold is provided into which polymeric material is sprayed. When spraying into a sharply contoured cavity, the sprayed polyurethane material accumulates in the brow area of the instrument panel. Unnecessary accumulation of polymer used to form the molded skin results in wasted material and added cost. The process of filling the sharp brow area causes the molded skin to be harder in that area than the other portions of the instrument panel. The process also may create a visible line on the surface of the instrument panel after it is filled with foam.

There is a need for a process for forming instrument panel skin having a relatively uniform thickness even in highly contoured areas such as the brow of an instrument panel. There is also a need to improve the quality of instrument panel skins so that a build up of sprayed polymer that is used to form the skin is not formed in deep concave areas of the mold.

These and other problems and disadvantages associated with the prior art process and instrument panels made according to the processes of the prior art are overcome as summarized below.

### SUMMARY OF THE INVENTION

According to one aspect of the present invention, a method of making a skin of an interior trim part for a vehicle is provided. The skin provides a cover defining an exterior surface of the interior trim part. The method includes providing a mold having a molding surface including at least one convex portion. A polymeric material is then sprayed or otherwise applied onto the mold surface with the exterior surface of the skin being formed on a convex portion of the mold. The skin is then allowed to at least partially cure, or “flash off,” before being removed from the mold. The skin is then turned inside out with the exterior surface being inverted to form a convex portion of the skin. The skin is then placed into a mold having a concave portion that the convex portion of the skin is placed against. Foam is then fed, injected, or sprayed into the skin while it is disposed in the concave portion of the mold and the foam is cured to form the interior trim part with the skin forming the cover of the interior trim part.

According to another aspect of the invention, a mold surface is preferably provided with a grain pattern that is transferred to the exterior surface of the skin.

The polymeric material may be a reactive urethane mixture or may be a polyvinylchloride composition.

According to other aspects of the invention, the convex portion of the mold surface may be a mirror image of the predefined shape. The concave portion of the mold in which the foam is injected into the skin corresponds to the predefined shape of the interior trim part. The polymeric material forming the skin is preferably sprayed onto the mold surface so that a layer of polymeric material having a uniform thickness is provided over the convex portion.

According to another aspect of the invention, an interior trim component made according to the process comprises an elastomeric skin formed on a mold surface having a convex portion that is formed in a skin forming mold. The skin is turned inside out after being formed on the convex portion of the skin forming mold. A urethane foam is injected to fill a cavity defined within the skin.

According to other aspects of the invention as it relates to the interior trim component formed by the process, the elastomeric skin may have a grain pattern that is formed on a concave portion of the skin when the skin is formed on the convex portion of the mold. The grain pattern is formed on a concave portion of the skin and turned inside out and filled with foam. The elastomeric skin may be a urethane mixture or may be a polyvinylchloride composition. The interior trim component may be an instrument panel that defines a brow area having a smaller radius than other portions of the instrument panel. The thickness of the skin in the brow area of the instrument panel is substantially the same as the thickness of the skin in the other portions of the instrument panel.

### BRIEF DESCRIPTION OF THE DRAWINGS

FIG. 1 is a fragmentary cross-sectional view of a male skin forming mold;

FIG. 2 is a fragmentary cross-sectional view of the male skin forming mold and a skin sprayed on the mold surface;

FIG. 3 is a cross-sectional view of an inverted skin placed in a female foaming mold; and

FIG. 4 is a cross-sectional view of the inverted skin filled with foam in the female foaming mold.

### DETAILED DESCRIPTION OF THE PREFERRED EMBODIMENT(S)

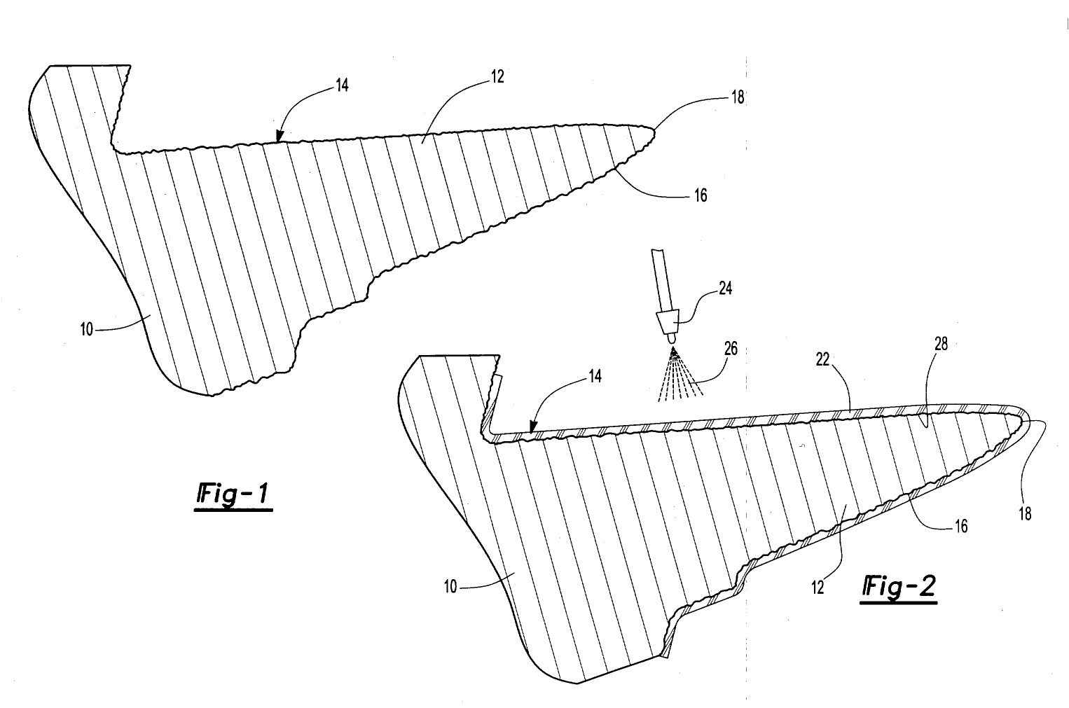

Referring to FIG. 1, a male skin forming mold 10 is shown in cross section taken through a convex portion 12 of the mold 10. The convex portion 12 may correspond to a brow portion or other projecting portion of an instrument panel or other interior trim part.

A mold surface 14 is provided with a textured surface or grain pattern 16. The grain pattern 16 may have a leather-like appearance. A sharp radius brow region 18 is defined by the convex portion 12 that may correspond to the brow of a dashboard. The “brow” refers to a portion of the instrument panel generally in front of the driver that extends over the instrument panel cluster toward the steering wheel.

Referring to FIG. 2, a skin 22 is shown as it is being formed on the mold surface 14. A polymer spray nozzle 24 is used to apply polymer in a spray 26 to the mold surface 14. The layer of polymer applied to form the skin is controlled to provide a generally uniform thickness skin having a thickness of between 0.5-2 mm. The skin 22 conforms to the mold surface 14, incorporating the grain pattern 16 on the concave side of the skin 28.

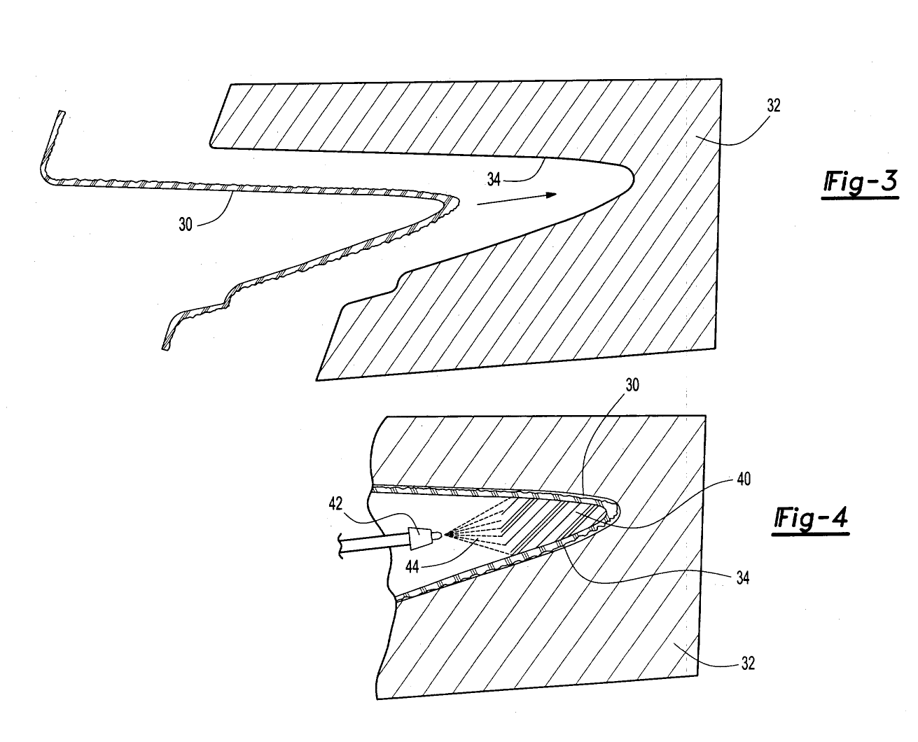

Referring to FIG. 3, an inverted skin 30 is shown being inserted into a female mold 32. The inverted skin 30 is the same article as skin 22 but has been turned inside out so that the concave side of the skin faces a concave surface 34 of the female mold 32. When inserted, the inverted skin 30 lines the concave surface 34 of the female mold 32.

Referring to FIG. 4, a foam 40 is injected into the inverted skin 30 by means of a foam injection nozzle 42. It should be noted that other methods of applying a foam may be used including any number of conventional methods of supplying a polymer foam to fill inside a skin. As shown in FIG. 4, the foam is only partially injected, but it should be understood that the entire interior of the inverted skin 30 is preferably filled with the foam 40. The foam injection nozzle 42 is shown applying a foam spray 44 to the inverted skin 30. The skin may be formed of a polyvinylchloride (PVC) composition or may also be formed by a spray urethane process. Spray urethane processes may include a two component polyurethane composition including a polyol and isocyanate. The foam 40 is preferably a urethane composition including a blowing agent, such as water, that causes the urethane composition to foam prior to solidifying as a substantially rigid yet resilient foam material. The foam 40 provides a backing for the inverted skin 30.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an interior trim part for a vehicle, the interior trim part having a skin defining an exterior surface of the interior trim part having a predefined shape comprising:
providing a first mold having a mold surface having a convex portion;
spraying a polymeric material onto the mold surface to form the skin with an exterior surface being formed on a concave portion of the skin;
waiting a period of time to allow the skin formed by the polymeric material to be at least partially cured;
removing the skin from the first mold;
turning the skin inside out with the exterior surface being inverted to form a convex portion of the skin;
placing the skin into a second mold having a concave portion that the convex portion of the skin is placed against;
injecting foam into the skin while disposed in the concave portion of the second mold; and
curing the foam to form the interior trim part with the exterior surface of the skin covering the interior trim part.

2. The method of claim 1 wherein the first mold surface is provided with a grain pattern that is transferred to the exterior surface of the skin.

3. The method of claim 1 wherein the polymeric material is a urethane mixture.

4. The method of claim 1 wherein the polymeric material is polyvinylchloride.

5. The method of claim 1 wherein the convex portion of the first mold surface is a mirror image of the predefined shape and the concave portion of the second mold corresponds to the predefined shape.

6. The method of claim 1 wherein the polymeric material is sprayed onto the mold surface with a uniform thickness over the convex portion.

7. An interior trim component for a vehicle that is made according to a process, wherein the trim component comprises:
an elastomeric skin formed on a first mold surface having a convex portion that is formed initially on a skin forming mold;
a urethane foam injected to fill a cavity defined within the skin, the skin being turned inside out after being formed on the convex portion of the skin forming mold prior to being filled with a foam.

8. The interior trim of claim 7 wherein the elastomeric skin has a grain pattern that is formed on a concave portion of the skin when the skin is formed on the convex portion of the first mold, the grain pattern being on a convex portion of the interior trim component after the skin is turned inside out and filled with foam.

9. The interior trim component of claim 7 wherein the elastomeric skin is a urethane mixture.

10. The interior trim component of claim 7 wherein the elastomeric skin is a polyvinylchloride mixture.

11. The interior trim component of claim 7 wherein the convex portion of the interior trim component defines a brow area of an instrument panel having a sharper radius than a less contoured portion of the instrument panel and wherein the thickness of the skin in the brow area is the same as the thickness of the skin in the less contoured portion of the instrument panel.

12. A method of making a skin of an interior trim part for a vehicle, the skin defining an exterior surface of the interior trim part having a predefined shape comprising:
providing a male mold having a mold surface defining an essentially convex portion;
spraying a polymeric material onto the mold surface to form the skin with an exterior surface being formed on a concave portion of the skin;
waiting for the skin formed by the polymeric material to at least partially cure;
removing the skin from the mold; and
turning the skin inside out with the exterior surface being inverted to form a convex portion of the skin.

13. The method of claim 12 wherein the male mold surface is provided with a grain pattern that is transferred to the exterior surface of the skin.

14. The method of claim 12 wherein the polymeric material is a urethane mixture.

15. The method of claim 12 wherein the polymeric material is polyvinylchloride.

16. The method of claim 12 wherein the convex portion of the male mold surface is a mirror image of the predefined shape and the concave portion of the female mold corresponds to the predefined shape.

17. The method of claim 12 wherein the polymeric material is sprayed onto the male mold surface with a uniform thickness over the convex portion.
